(19) United States
(12) Patent Application Publication
(10) Pub. No.: US 2013/0126018 A1
(43) Pub. Date: May 23, 2013

(54) PRESSURE CONTROL DEVICE FOR IRRIGATION PLANTS

(71) Applicant: Arno Drechsel, Lienz (AT)

(72) Inventor: Arno Drechsel, Lienz (AT)

(21) Appl. No.: 13/639,153

(22) PCT Filed: May 6, 2011
(86) PCT No.: PCT/IB2011/052015

§ 371 Date: Nov. 29, 2012

(30) Foreign Application Priority Data
May 7, 2010 (IT) VI2010A000129

(51) Int. Cl. G05D 16/06

(52) U.S. Cl. CPC G05D 16/0608
USPC 137/505.25

(57) ABSTRACT

A pressure regulator for irrigation plants includes a main body with a central conduit having an inlet port and an outlet port for the liquid, a chamber with variable volume fluidly connected to the outlet port for adjusting the pressure variations and having a side wall elastically deformable between a maximum volume configuration and a minimum volume configuration, and a shutter member associated with the elastic wall for sliding in the conduit between a rest position and a work position. The central conduit includes a damping chamber interposed between the outlet port and the regulation chamber to slow the outflow of liquid from the latter towards the former and to avoid the complete emptying of the regulation chamber before the re-opening of the flow through the inlet port upon high water hammering.

### FIELD OF APPLICATION

The present is generally applicable to the technical field of devices for irrigation, and in particular has as object a liquid pressure regulator.

### STATE OF THE ART

As is known, in irrigation plants, for example of the so-called “center pivot” type, it is essential to regulate the supply pressure of the irrigation liquid in a manner so as to maintain its outlet pressure nearly constant, and consequently assure a regular supply of liquid for the ground.

For such purpose, suitable pressure regulator devices are used which are mounted at the outlet ends of the supply conduits, upstream of a corresponding diffuser adapted to direct the flow in a suitable manner.

Such adjusters, generally known as “flow-through” regulators, have a main body with a central conduit open at the ends for the passage of the irrigation liquid and a chamber for regulating the pressure of the irrigation water, fluidly connected to the outlet of the conduit.

Downstream of the main body, a diffuser nozzle is mounted whose outlet diameter, selected as a function of the flow rates to be supplied, contributes to determining a fairly high stagnation pressure inside the regulation chamber.

Such regulators also have an axially slidable shutter member for selectively varying the inlet port of the liquid inside the central conduit in response to a pressure variation sensed in the chamber.

The adjustment of the position of the shutter relative to the passage port therefore regulates the pressure of the water exiting from the regulator, independent of the flow.

In order to adjust the position of the shutter, known regulators generally have a thin membrane with non-elastic behavior fixed to the regulation chamber and operatively connected with the shutter member.

Under the action of the water coming from the outlet port, the membrane is raised, allowing the shutter to slide along the axis in the closing direction of the inlet port.

In order to oppose the action of the water pressure on the membrane, and thus on the shutter, metal springs are usually used, of compression type and generally preloaded, which interact with the movable shutter until a position of dynamic equilibrium is reached, thus adjusting the pressure.

Solutions of this type are known from U.S. Pat. No. 7,048,001 and U.S. Pat. No. 5,881,757, among others.

Nevertheless, such solutions are affected by various problems in particular tied to the presence of significant oscillatory motions of the movable shutter, with the consequent sudden increase of the pressure and triggering of an irregular motion that facilitates the rise of vibrations.

A pressure regulator produced by the same Applicant and described in the Italian patent application VI2009A000170 is also known, which has an elastic membrane that delimits the regulation chamber.

In this manner, the counter-pressure generated at the emission nozzle causes the swelling of the elastic membrane that lifts the shutter, in such a manner regulating the pressure.

This device, while ensuring optimal performances in terms of control of the vibrations upon water hammering, was in any case shown to be improvable.

Indeed, it is observed that, in the presence of particularly intense water hammering, and even more so with large-diameter emission nozzles, when the shutter blocks the inlet port of the liquid, the membrane tends to return to rest position too quickly, emptying the regulation chamber.

Consequently, there is a sudden downward sliding of the shutter which reopens the central conduit, allowing the passage of the fluid.

In this manner, in specific conditions, a cyclic opening/closing motion is established with consequent emptying and refilling of the regulation chamber that can generate strong vibrations, with consequent wear of the components and functioning irregularity.

### PRESENTATION OF THE INVENTION

The object of the present invention is to at least partially overcome the abovementioned drawbacks, by making a liquid pressure regulator, particularly for irrigation plants, which is very efficient and relatively inexpensive.

One particular object is to make a pressure regulator that is substantially free of vibrations upon water hammering of even high intensity produced by the incoming liquid.

One particular object is to make a pressure regulator that is free of sudden variations of outlet pressure and oscillations inside the regulator itself, in particular in the presence of emission nozzles having relative large diameter.

Another object of the present invention is to obtain a pressure regulator which allows controlling the movement of the shutter by preventing excessive oscillations thereof in the presence of strong pressure changes.

A further object of the invention is to obtain a pressure regulator that allows obtaining the perfect closure of the inlet port of the liquid in the presence of high incoming liquid pressures.

Such objects, as well as others which will appear clearer below, are reached by a pressure regulator in accordance with claim 1, comprising a main body with a central passage having an inlet port and an outlet port for the irrigation liquid and defining a longitudinal axis, a chamber with variable volume fluidly connected to said outlet port for sensing and adjusting pressure variations of the liquid, said regulation chamber having a side wall elastically deformable between a maximum volume configuration and a minimum volume configuration in response to the sensed pressure, a shutter member associated with said elastic wall for axially sliding in said body between a rest position distal from said inlet port and a work position proximal thereto corresponding respectively to said minimum and maximum volume configurations of said elastic wall.

According to a particular characteristic of the invention, the central conduit comprises a damping chamber interposed between the outlet port and the sensing chamber, in order to slow the outflow of liquid from the latter towards the former.

In this manner, it is avoided that—with the inlet port shut, e.g. due to a high water hammering, and in particular with nozzles with particularly large outlet diameter—the regulation chamber is quickly emptied by moving the shutter member towards the distal position and favoring the new inflow of liquid at high pressure.

Such occurrence could trigger a sudden closing and opening movement of the inlet port by the shutter member with consequent rise of vibrations that are damaging both for the integrity of the components and the normal functioning of the regulator.

By contrast, the damping chamber will allow the regulation chamber, which will reach a volume comprised between or coinciding with the maximum and minimum volumes following the counter-pressure generated by the presence of the diffusion nozzle, to be emptied in a gradual manner, so as to remain still partially full when the inlet port is reopened, allowing the new incoming flow. The regulator will thus assume a more regular behavior, eliminating the vibrations.

Advantageously, independent of the presence of the damping chamber, the main body could have an upper end portion which slidably houses an upper end section of the shutter member with the interposition of an annular elastic seal.

Suitably, an annular pressure member could also be provided for, placed on the elastic seal in order to radially deform it due to the pressure of the incoming irrigation liquid and to brake the upward sliding of said shutter member.

In this manner, due to the pressure of the incoming liquid in the central channel, the pressure member will flatten the seal, which will radially expand and come to increase the friction on the shutter member.

Therefore, the latter will have its motion towards the proximal closure position braked, preventing the sudden closure of the inlet port and allowing a finer adjustment of the pressure.

According a further particularly advantageous aspect of the invention, the upper end portion of the main body will house a fixed member susceptible to cooperate with the shutter member for defining the inlet port. The upper section of the shutter member will in turn have a closing upper end facing a lower portion of the fixed member.

Advantageously, the latter will be substantially cylindrical, with a lower axial section and an upper axial section having calibrated diameter smaller than that of the lower section and substantially equal, minus normal tolerances, to that of the closing upper end of the shutter member in order to allow the complete closure of said inlet port, particularly in the presence of low flows and nozzles of relatively reduced outlet diameter.

In addition, the fixed member will also comprise tilted surface means for guiding and centering the upper end of the shutter member into the calibrated cylindrical section.

In this manner, in the presence of a suitable counter-pressure value downstream of the shutter member, the latter can be inserted in the fixed member in a manner so as to close the inlet port in a nearly complete manner, ensuring even greater precision in the flow regulation.

As will be even clearer below, the particular configuration of the fixed member will not be necessarily bound to the present of the damping chamber and/or to that of the pressure member.

Thus, a regulator only provided with the single fixed member thus configured, in addition to the closing member, will in any case ensure a more regular control of the flow with respect to known regulators.

Advantageous configurations of the invention are defined in the dependent claims.

### BRIEF DESCRIPTION OF THE DRAWINGS

Further characteristics and advantages of the invention will be clearer in light of the detailed description of several preferred but not exclusive embodiments of a pressure regulator, illustrated as a non-limiting example with the aid of the drawing table set in which:

FIG. 1 is a sectional front view of the regulator according to the invention where the shutter member is in a distal position from the inlet port 3 and the detection chamber is in minimum volume configuration;

FIG. 1a is an enlarged view of a detail of FIG. 1;

FIG. 2 is a perspective view in section of the regulator in the condition of FIG. 1;

FIG. 3 is a front view in section of the regulator according to the invention in which the shutter member is in a position proximal to the inlet port and the detection chamber is in maximum volume configuration;

FIG. 4 is a perspective view in section of the regulator in the condition of FIG. 3;

FIG. 5 is an enlarged front view in section of a first detail of the regulator in the condition of FIG. 1;

FIG. 6 is an enlarged front section view of the detail in FIG. 5 in the condition of FIG. 3;

FIG. 7 is an enlarged front section view of a second detail of the regulator according to the invention;

FIG. 8 is a bottom view of the detail of FIG. 7;

FIG. 9 is a view of a first detail of the detail of FIG. 7;

FIG. 10 is a view of a second detail of the detail of FIG. 7.

### DETAILED DESCRIPTION OF SEVERAL PREFERRED EMBODIMENTS

With reference to the mentioned figures, the pressure regulator according to the invention, indicated with 1 in its entirety, will be of flow-through type, and will be employable in irrigation plants, e.g. of center pivot type, possibly coupled, in a known manner, with diffuser devices or the like.

According to the invention, the pressure regulator 1 will comprise a main body 2 with a central conduit 3 having an inlet port 4 and an outlet port 5 for the irrigation liquid and defining a longitudinal axis X.

The main body 2, having in the illustrated configuration, in a merely exemplifying manner, external bell-like shape, will have upper 6 and lower 7 axial end portions that are substantially tubular.

For example, the main body 2 can be formed by two half-shells, an upper 2′ and a lower 2″, stably and/or removably coupled together and comprising respective axial end portions 6, 7.

Advantageously, the two half-shells 2′, 2″ can be snap coupled together in order to speed up and simplify the assembly thereof.

In addition, the lower end portion 7 can be configured for anchoring, according to any one mode known to the man skilled in the art, a fluid jet emission nozzle, not illustrated since it is per se known. Such nozzle is adapted to direct the outgoing flow towards the outside and is possibly associated with a diffuser of known type.

At its interior, the main body 2 will also enclose a chamber 8 with variable volume fluidly connected to the outlet port 5 for sensing and regulating the liquid pressure variations.

The regulation chamber 8 will be defined by a shaped bottom wall 9 obtained inside the main body 2, for example on the lower half-shell 2″, and by an elastically deformable side wall 10.

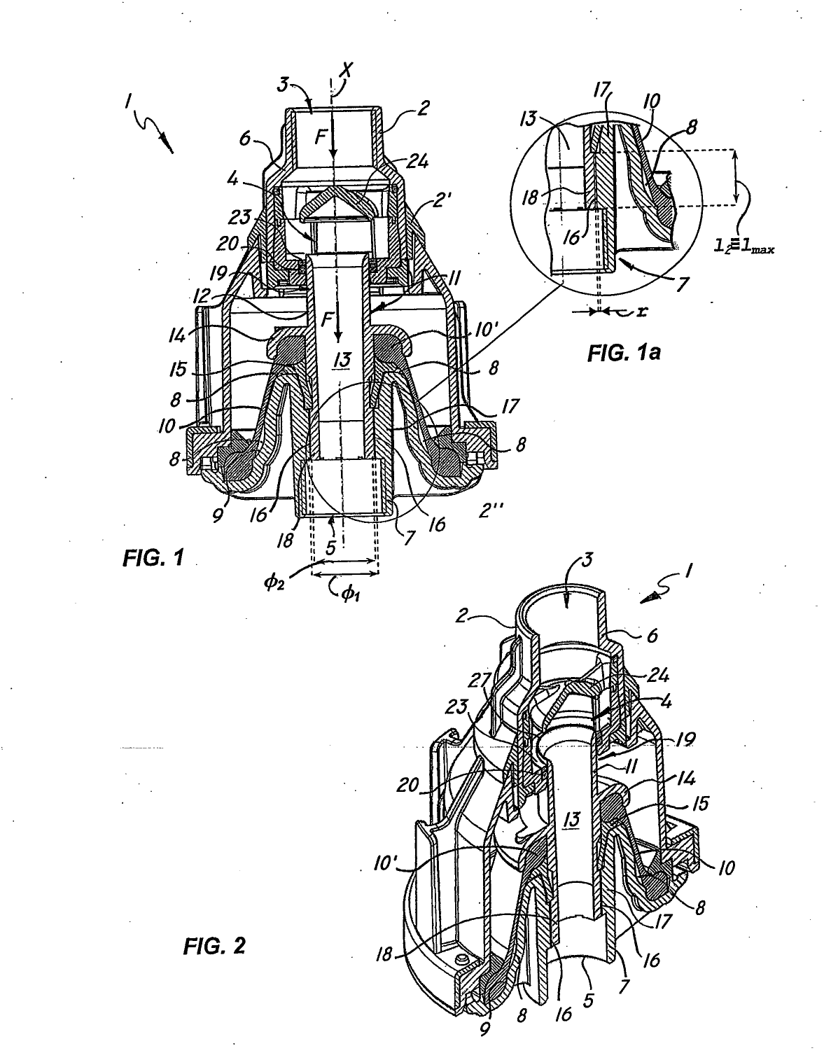

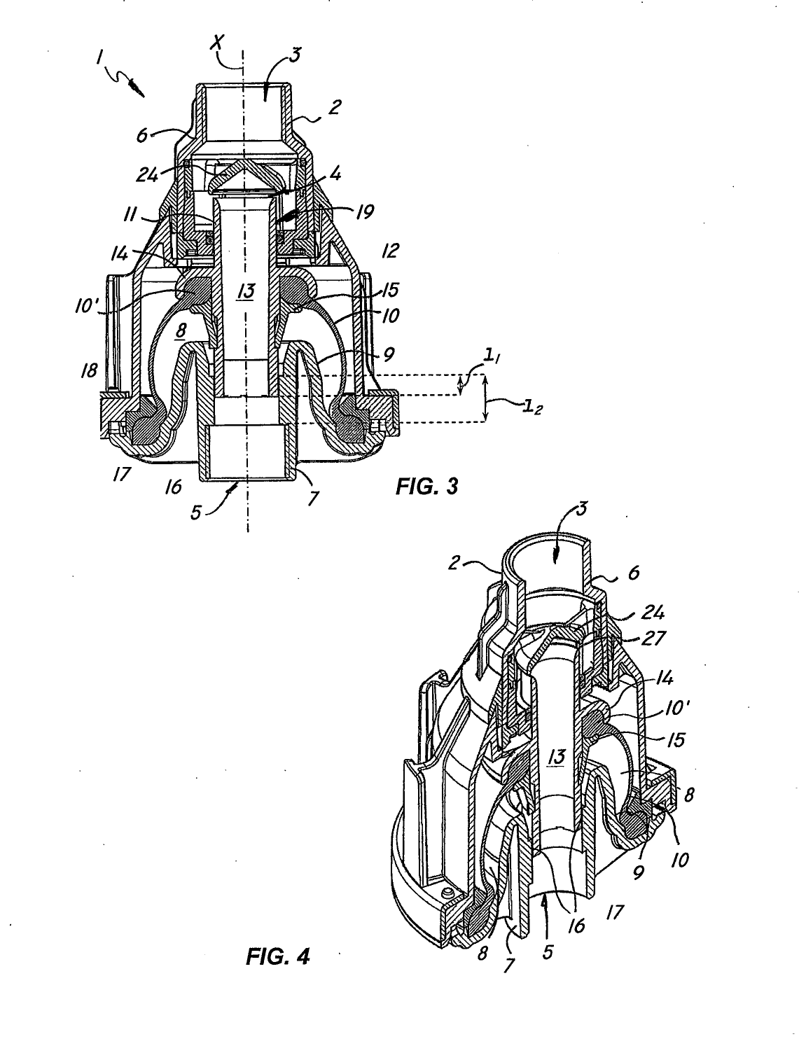

The side wall 10—under the effect of the counter-pressure sensed in the chamber 8, which will naturally be created downstream of the outlet port 5 due to the presence of the nozzle—will be susceptible to being elastically deformed between a minimum volume configuration and a maximum volume configuration, illustrated more clearly in FIG. 1 and FIG. 3, respectively.

According to a preferred but not exclusive configuration for the invention, the elastic wall 10 can be defined by an elastomer member. The membrane 10 will thus be susceptible to undergo deformations of elastic type when loaded by the current pressure in the regulation chamber 8, returning to the original rest configuration once unloaded.

In order to minimize the problems deriving from the water hammering, in a particular embodiment of the invention the elastomer wall 10 can have a form (e.g. generally frustoconical) that is substantially complementary to that of the bottom wall 9 of the regulation chamber 8, so as to substantially come into contact with the same in rest position.

In such a manner, the interspace will be eliminated between the upper surface of the bottom wall 9 and the lower surface of the elastomer wall 10, which accentuates the rise of vibration phenomena.

In a preferred but not exclusive embodiment, the wall or elastomer membrane 10 can be made of silicon rubber or a similar material.

The elastomer wall 10 will also be associated with a shutter member 11 susceptible to sliding axially inside the main body 2 following the deformation of the wall 10 itself for progressively opening or closing the inlet port 4 in response to the counter-pressure sensed in the chamber 8.

In particular, the shutter member 11 and the membrane 10 will be respectively sized in a manner such that the former can be moved between a rest position distal from the inlet port 4, corresponding to the empty chamber 8 condition, and a work position proximal to the inlet port 4, with at least a partial closing thereof, corresponding to the maximum volume configuration for the regulation chamber 8.

Such distal and proximal positions of the shutter member 11 are respectively illustrated in FIGS. 1-2 and in FIGS. 3-4.

Naturally, the shutter member 11 can assume any intermediate position between the two limit positions, as a function of the current operating pressure inside the regulation chamber 8.

Due to the elastomeric nature, the elastically deformable wall 10 will be susceptible to being elastically stretched under the action of the liquid pressure, allowing not only the axial sliding of the shutter member 11 from the rest to the work position, but also the absorption of possible variations or water hammers that could occur in the irrigation plant, e.g. upon starting. This is because after the elastic stretching, the lower surface area of the wall 10 increases, and this acts against the pressurized liquid.

As is visible in the figures, the shutter member 11 will comprise a substantially tubular central body 12 with an inner axial passage 13 operatively crossed by the irrigation liquid in the direction of the arrow F when the regulator 1 is in use.

The axial passage 13 will fluidly connect the inlet port 4 with the regulation chamber 8. The outlet section of the axial passage 13 will define the outlet port 5 for the irrigation liquid.

The anchoring of the elastomer wall 10 to the shutter member 11 can be obtained, in a merely exemplifying manner, through an annular flange 14 radially projecting from the central body 12 and by a retainer ring 15 snap coupled with the latter.

The elastic wall 10 will have a toroidal portion 10′ inserted between the flange 14 and the ring 15 so as to be locked on the shutter member 11.

According a particular feature of the invention, the main body 2 will also enclose a damping chamber 16 interposed between the outlet port 5 and the regulation chamber 8 and adapted to slow the liquid flow from the latter towards the former when the elastomer wall 10 tends to pass from the work condition to the unloaded chamber 8 condition.

In this manner, one avoids the complete or too-quick emptying of the regulation chamber 8 before the reopening of the inlet port 5 and the re-establishment of the flow F.

The main body 2 can comprise, at the lower portion 7 thereof, a cylindrical section 17 with predetermined inner diameter φ₁ in which a lower end section 18 of the shutter member 11 will be slidably housed.

Such end section 18 will have a lower outer diameter φ₂ than the inner diameter φ₁ of the lower cylindrical section 17 of the main body 2, so as to delimit therewith a cylindrical interspace defining the damping chamber 16, as is more clearly illustrated in the detail of FIG. 1a.

Advantageously, the cylindrical interspace 16 will have a cross section substantially shaped as an annular crown.

In addition, the difference between the outer φ₂ and inner φ₁ diameters defined above will preferably be very small, e.g. a few tenths of a millimeter, and in any case such to define a radial size r for the interspace 16 that is preferably less than 1 mm.

Nevertheless, such values can also be different and the interspace 16 can be sized as a function of the overall size of the regulator 1.

In substance, the damping chamber 16 must define a narrow section or in any case a reduction of section between the outlet port 5 and the regulation chamber 8.

The shutter member 11 will also be sized in order to keep its lower end section 18 always housed in the lower end portion 7 of the main body 2, and in particular in the cylindrical section 18, both in its rest position and in any one work position, including that proximal to the inlet port 5 in which the regulation chamber 8 has maximum volume.

Therefore, the cylindrical interspace 16 will have a variable axial length with maximum value lₘₐₓ not greater than the axial length l₂ of the lower cylindrical section 17 of the main body 2, e.g. of equal value.

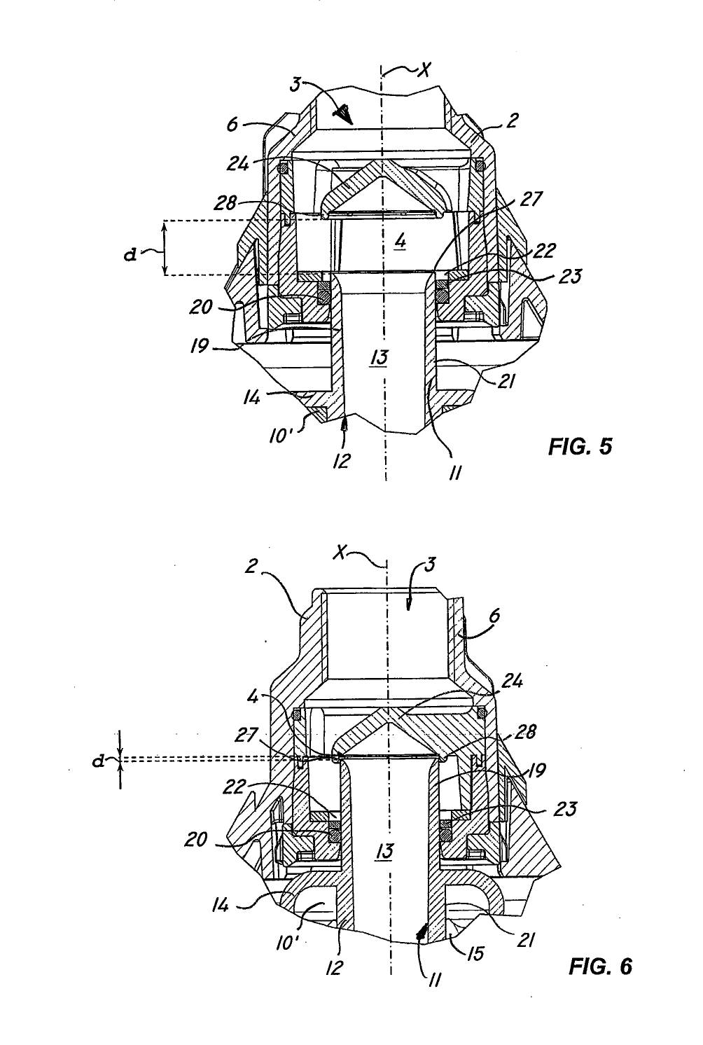

In turn, the upper end portion 6 of the main body 2 will slidably house an upper end section 19 of the shutter member 11, with the interposition of an annular elastic seal 20, as is more clearly illustrated in FIGS. 5 and 6.

The elastic seal 20 will be placed coaxially with the cylindrical shutter member 11, in contact with the outer wall 21 thereof, preferably at the upper section 19.

The seal 20, which can in particular be a common O-ring, will preferably be made of any one elastomer material. In addition, a groove 22 will be stably housed to size and obtained in the wall of the upper end portion 6 of the main body 2.

The seal 20, in a known manner, will have the task of preventing the liquid from exiting from the conduit 3 and affecting zones of the main body 2 which must remain dry.

Inside the same groove 22, an annular pressure member 23 will also be inserted, placed on and in contact with the elastic seal 20.

The pressure member 23 will preferably be substantially rigid in order to uniformly press on the seal 20 due to the pressure of the incoming irrigation liquid, so as to cause the radial deformation thereof.

In this manner, the seal 20 will function as a brake against the upward sliding of the shutter member 11.

The action of the pressure member 23 will be mainly concentrated at the initial phase of the water hammer, in order to transfer a force of impulsive type to the seal 20 which will cause its maximum transient deformation for braking the shutter member 11.

During operation, instead, the seal 20 will normally be compressed, so as to carry out the normal fluid isolation task, without blocking the correct functioning of the shutter member 11.

The material used for the annular pressure member 23 can be any material with suitable rigidity, e.g. metal or polymer material, in particular Teflon® or the like.

It is clear that the operation as annular seal 20 is not conditioned by the presence or lack of presence of the damping chamber 16, so that it is possible to make the regulator 1 even without the latter.

The pressure member 23 will also serve to prevent extraneous particles from being inserted in the groove 22, ensuring greater protection against dirt.

According to a further aspect, inside the upper end portion 6 of the main body 2, a fixed member 24 can be housed that is susceptible to cooperate with the shutter member 11, which will approach/move away from the fixed member in order to vary the mutual distance d, defining the inlet port 4.

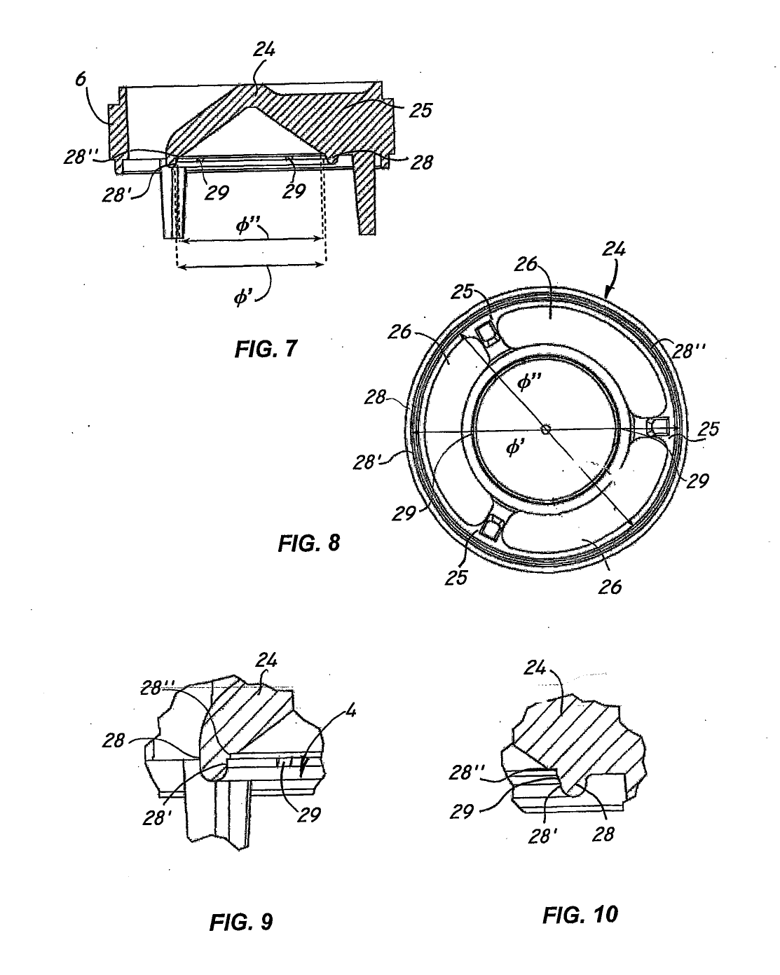

The fixed member 24, visible in section in FIG. 7, will have substantially convex shape and can be connected to the inner wall of the upper portion 6 by means of one or more radial spokes 25. In this manner, openings 26 are defined, visible in FIG. 8, for the passage of the liquid towards the inlet port 4 of the central conduit 3.

The shutter member 11 will have a closing upper end 27 facing a lower portion 28 of the fixed member 24.

Such lower portion 28 will be substantially cylindrical, with a lower axial section 28′ having predetermined inner diameter φ′ and an upper axial section 28″ having smaller diameter φ″ than that of the lower section 28′, as is more clearly visible from FIG. 9.

The diameter φ″ of the upper section 28″ will also be calibrated to a value that is substantially equal, minus normal tolerances, to that of the closing upper end 27 of the shutter member 11.

In this manner, the closing upper end 27 of the shutter member 11 can snuggly fit the cylindrical portion 28 of the fixed member 24, in order to obtain, in specific counter-pressure conditions, the complete closure of the inlet port 5.

Advantageously, the fixed member 24 will also comprise inclined plane means for guiding and centering the upper end 27 of the shutter member 11 into the calibrated cylindrical section 28″.

In the illustrated configuration, the inclined plane means comprise a plurality of radial projections 29 defining respective inclined planes converging towards the axis X of the regulator 1.

The projections 29 will be arranged on the inner periphery of the cylindrical portion 28 of the fixed member 24, at the greater diameter φ′.

Operatively, the tilted surfaces 29 will act on the shutter member 11 during its sliding towards the inlet port 4 in order to keep it in perfectly axial position, avoiding that its closing upper end 27 is blocked on the wall of the fixed member 24, not allowing the complete closure of the inlet port 4.

Also in this case, it is clear that the functioning of the tilted surface means 29 is not necessarily dependent on the presence of the damping chamber 16 and/or of the pressure means 23. Therefore, in a particular configuration, the regulator 1 could also be provided with inclined plane means 29 without the damping chamber 16 and/or pressure member 23.

In use, the irrigation liquid, generally water, will enter into the regulator 1 through the inlet port 4; it will flow through the axial passage 13 of the shutter member 11 in order to reach the outlet port 5 and from here, it will flow through the damping chamber 16 to the regulation chamber 8.

Therefore, once it has reached the regulation chamber 8, the water will fill the chamber and will hit the lower surface of the elastomer wall 10. The latter, due to its elastomeric nature, will be elastically stretched, expanding its surface and allowing the shutter member 11, fixed thereto, to slide upward along the axis X, passing from the distal rest position to the proximal work position or to an intermediate position.

On the other hand, this will cause the progressive shutting of the inlet port 4, or in other words the reduction of the distance d between the closing end 27 and the cylindrical portion 28 of the fixed member 24, until a position of dynamic equilibrium is reached, in such a manner regulating the pressure.

The elastomeric nature of the elastic wall 10 will allow the same to absorb sudden pressure changes, avoiding oscillations of the shutter member 11 and absorbing possible water hammers. In the case of particularly high water hammering, an even more complete closure of the inlet port 4 is produced, particularly if one is in the presence of guiding and centering means 29.

In the substantial absence of incoming flow F, the elastomer wall 10 will tend to return to its rest position, by emptying the regulation chamber 8. Nevertheless, the damping chamber 16 will prevent that such emptying occurs in an overly rapid manner.

On the contrary, the damping chamber 16 will allow the regulation chamber 8 to be emptied in a gradual manner due to the elastomer wall 10 which returns to its non-deformed condition, re-opening the flow F through the inlet port 5 before the regulation chamber 8 is emptied, avoiding the onset of vibrations.

Given that described above, it is evident that the regulator according to the invention attains the pre-established objects, in particular it allows a regulation of the liquid pressure which is free of sudden variations, with consequent damping of the oscillations inside the regulator, even in the presence of emission nozzles with particular large diameter.

The regulator according to the invention is susceptible to numerous modifications and variants, all falling within the inventive concept expressed in the enclosed claims. All the details can be substituted with other technically equivalent elements, and the materials can be different according to needs, without departing from the scope of the invention.

Even if the regulator was described with particular reference to the enclosed figures, the reference numbers used in the description and in the claims are employed for improving the comprehension of the invention and do not constitute any limitation of the claimed protective scope.

1. A pressure regulator for irrigation plants, comprising:
a main body with a central conduit defining a longitudinal axis and having an inlet port and an outlet port for the irrigating liquid;
a regulation chamber with variable volume fluidly connected with said outlet port for sensing and regulating pressure variations of the liquid, said regulation chamber having a side wall elastically deformable between a maximum volume configuration and a minimum volume configuration in response to the sensed pressure;
a shutter member associated with said elastic wall for axially sliding in said central conduit between a rest position distal from said inlet port and a work position proximal thereto corresponding respectively to said maximum and minimum volume configurations of said regulation chamber;
wherein said central conduit comprises a damping chamber interposed between said outlet port and said regulation chamber in order to slow an outflow of liquid from the latter towards the former and avoid a complete emptying of said regulation chamber before a re-opening of flow through said inlet port upon high water hammering.

2. Regulator as claimed in claim 1, wherein said main body comprises substantially tubular upper and lower axial end portions having respective predetermined inner diameters.

3. Regulator as claimed in claim 2, wherein said shutter member comprises an inner tubular passage for fluidly connecting said inlet port with said damping chamber and having a substantially cylindrical lower end section slidable in said lower axial end portion for delimiting therewith a cylindrical interspace defining said damping chamber.

4. Regulator as claimed in claim 3, wherein said shutter member is sized for maintaining said cylindrical lower end section housed in said lower axial end portion of said main body both in said distal position and said proximal position.

5. Regulator as claimed in claim 3, wherein said cylindrical interspace has a variable axial length with maximum value not greater than the axial length of said lower axial end portion of said main body.

6. Regulator as claimed in claim 2, wherein said upper axial end portion of said main body slidably houses an upper end section of said shutter member with the interposition of an annular elastic seal.

7. Regulator as claimed in claim 6, wherein said elastic seal externally surrounds said upper end section of said shutter member, in contact therewith, an annular pressure member also being provided which is placed on said elastic seal for radially deforming said elastic seal due to pressure of incoming irrigation liquid and braking an upward sliding of said shutter member.

8. Regulator as claimed in claim 6, wherein said upper axial end portion of said main body houses a fixed member susceptible to cooperate with said shutter member to define said inlet port, said upper end section of said shutter member having a closing upper end facing a lower portion of said fixed member.

9. Regulator as claimed in claim 8, wherein said lower portion of said fixed member is substantially cylindrical with a lower axial section having a predetermined inner diameter and an upper axial section having a calibrated diameter substantially equal to that of said closing upper end of said shutter member to allow the complete closure of said inlet port by said shutter member.

10. Regulator according to claim 9, wherein said fixed member comprises inclined plane means for guiding and centering said upper end of said shutter member into said upper axial section.
